(19) United States
(12) Patent Application Publication
(10) Pub. No.: US 2016/0154154 A1
(43) Pub. Date: Jun. 2, 2016

(54) CAMERA MODULE

(71) Applicant: Samsung Electro-Mechanics Co., Ltd., Suwon-si (KR)

(72) Inventors: Kang Jin LEE, Suwon-si (KR); Soon Chul KWON, Suwon-si (KR); Kyoung Soo SON, Suwon-si (KR)

(73) Assignee: Samsung Electro-Mechanics Co., Ltd., Suwon-si (KR)

(21) Appl. No.: 14/944,814

(22) Filed: Nov. 18, 2015

(30) Foreign Application Priority Data
Nov. 28, 2014 (KR) 10-2014-0168477

(51) Int. Cl. G02B 5/20; H04N 5/225; G02B 7/00; G02B 5/00; G02B 7/02

(52) U.S. Cl. CPC G02B 5/208; G02B 5/003; G02B 7/02; G02B 7/006; H04N 5/2253; H04N 5/2254

(57) ABSTRACT

A camera module includes: a housing; a lens barrel coupled to or disposed in the housing; an infrared filter fixed to the housing; and a blocking layer disposed on the infrared filter, wherein a width of a corner region of the blocking layer and a width of a central region of the blocking layer are different from each other.

### CROSS-REFERENCE TO RELATED APPLICATION(S)

This application claims the benefit of Korean Patent Application No. 10-2014-0168477 filed on Nov. 28, 2014, in the Korean Intellectual Property Office, the entire disclosure of which is incorporated herein by reference for all purposes.

### BACKGROUND

1. Field

The following description relates to a camera module.

2. Description of Related Art

Portable communications terminals such as cellular phones, personal digital assistants (PDA), portable personal computers (PC), and the like, have generally been implemented with the ability to perform the transmission of video data as well as the transmission of text or audio data. In accordance with this trend, camera modules have been standardly installed in the portable communications terminals in order to enable the capturing of video data, video chatting, and the like.

The camera module may include at least one lens stacked therein, and light passing through the lens may be collected in an image sensor and stored as data in a memory in an apparatus. However, since incident external light within such a camera module may be refracted while passing through the lenses thereof, the light passing through the lenses may not be directly collected in the image sensor, and may arrive at and be reflected from an electronic component in the vicinity of the image sensor or may be reflected from a bonding wire connecting the image sensor and a printed circuit board to each other, and may then be incident on the image sensor.

In addition, the light passing through the lens may be reflected from an internal component, or the like, of the camera module and may then be incident on the image sensor.

In this case, a flare phenomenon caused by a problem such as light spreading, or the like, may be generated, which may have a negative influence on image quality. Therefore, there is a need to prevent light from being reflected from internal components, or the like, of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a camera module includes: a housing; a lens barrel coupled to or disposed in the housing; an infrared filter fixed to the housing; and a blocking layer disposed on the infrared filter, wherein a width of a corner region of the blocking layer and a width of a central region of the blocking layer are different from each other.

The width of the corner region of the blocking layer may be narrower than a width of the central region of the blocking layer.

The blocking layer mat be disposed at edges of the infrared filter.

The blocking layer may be spaced apart from an outer edge of the infrared filter.

The blocking layer may be disposed on at least one of an upper surface and a lower surface of the infrared filter.

The camera module may include a protrusion portion disposed on an internal surface of the housing and protruding toward an optical axis, wherein an edge of the infrared filter is attached to the protrusion portion.

The blocking layer may protrude further toward the optical axis in comparison to the protrusion portion.

A distance D1 from a virtual line bisecting the infrared filter to the central region of the blocking layer is D1 and a distance D2 from the virtual line bisecting the infrared filter to the corner region of the blocking layer may satisfy the expression: 1<D2/D1≦2.

The camera module may further include an image sensor disposed below the infrared filter and having a light receiving surface, wherein the blocking layer is configured to block light from being incident on a region other than the light receiving surface.

The blocking layer may be a light absorbing layer.

The blocking layer may be black.

The infrared filter may be adhered to the housing by an adhesive.

The central region of the blocking layer may protrude further toward an optical axis in comparison to other regions of the blocking layer.

According to another general aspect, a camera module includes: a housing; a lens barrel coupled to or disposed in the housing; an infrared filter fixed to the housing; and a blocking layer disposed on the infrared filter, wherein a first distance from a virtual line bisecting the infrared filter to a central region of the blocking layer and a second distance from the virtual line bisecting the infrared filter to a corner region of the blocking layer are different from each other.

The second distance may be greater than the first distance.

The first distance and the second distance may satisfy the expression, 1<D2/D1≦2, wherein D1 denotes the first distance and D2 denotes the second distance.

Other features and aspects will be apparent from the following detailed description, the drawings, and the claims.

### BRIEF DESCRIPTION OF THE DRAWINGS

FIG. 1 is a schematic cross-sectional view of an example of a camera module.

FIG. 2 is an enlarged view of an example of part A of FIG. 1.

FIG. 3 is an enlarged view of another example of part A of FIG. 1.

FIG. 4 is a plan view of an infrared filter and a blocking layer included in the camera module according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

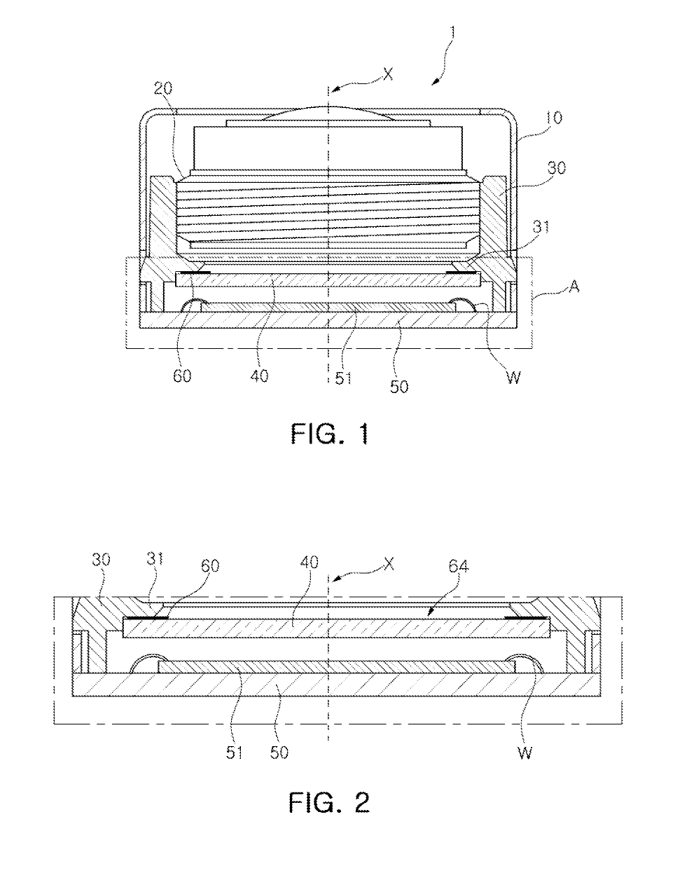

Terms with respect to directions are defined in the following description. As viewed in FIG. 1, an optical axis direction refers to a vertical direction, based on a lens module.

FIG. 1 is a schematic cross-sectional view of a camera module 1 according to an example.

Referring to FIG. 1, the camera module 1 includes a lens barrel 20, a housing 30, a case 10, an infrared (IR) filter 40, an image sensor 51, a printed circuit board 50, and a blocking layer 60.

The lens barrel 20 may have a hollow cylindrical shape so that at least one lens (not illustrated) for imaging a subject may be accommodated therein. The lens may be provided in the lens barrel 20 on an optical axis X for focusing light introduced from the outside. The optical axis X may be formed at the center of the lens.

The lens barrel 20 is coupled to the housing 30. For instance, the lens barrel 20 may be disposed in the housing 30.

The lens barrel 20 is configured to move in the optical axis direction to perform an auto-focusing function or zooming function. In order to move the lens barrel 20 in the optical axis direction, an internal portion of the housing 30 may be provided with an actuator (not illustrated) including a voice coil motor (VCM). The actuator (not illustrated) may include a coil (not illustrated), a magnet (not illustrated), and a yoke (not illustrated). The coil (not illustrated) may electromagnetically interact with the magnet (not illustrated) adjacent thereto to move the lens barrel 20 in the optical axis direction. For example, when power is applied to the coil (not illustrated), driving force may be generated by an electromagnetic interaction between the magnet (not illustrated) and the coil (not illustrated), and the lens barrel 20 may move in the optical axis direction by the driving force.

However, a transfer means of the lens barrel 20 is not limited to an actuator including a VCM. For instance, various schemes such as a mechanical driving scheme, a piezoelectric driving scheme using a piezoelectric element, or the like, may be used.

The case 10 is coupled to the housing 30 to enclose an outer surface of the housing 30, and may serve to block electromagnetic waves generated when the camera module 1 is being driven. For instance, when the camera module 1 is driven, electromagnetic waves may be generated, and in a case in which the electromagnetic waves as described above are discharged externally, the electromagnetic waves may have an influence on other electronic components to thereby cause communications errors or a malfunctioning therein.

According to an example, the case 10 may be formed of a metal to thereby be grounded by a ground pad provided on the printed circuit board 50. Therefore, the case 10 may block electromagnetic waves.

Alternatively, in another example in which the case 10 is formed of a plastic injection-molded product, a conductive paint may be applied on an internal surface of the case 10 to block electromagnetic waves. The conductive paint may be a conductive epoxy, but is not limited thereto. For instance, various materials having conductivity may be used in the conductive paint. Furthermore, instead of conductive paint being used, a conductive film or conductive tape may be attached to the internal surface of the case 10.

The image sensor 51, which collects light incident through the lens barrel 20 to generate an image signal, may be formed of a complementary metal oxide semiconductor (CMOS) sensor or a charge coupled device (CCD) sensor. The image sensor 51 is provided with a light receiving surface for capturing an image. The image sensor 51 is mounted on the printed circuit board 50 and is electrically connected to the printed circuit board 50 by a bonding wire (W). The printed circuit board 50 is coupled to a lower portion of the housing 30. An image of a subject may be collected by the image sensor 51 and may be stored as data in a memory in an apparatus, and the stored data may be displayed as the image by a display medium in the apparatus.

The infrared filter 40 is attached to the housing 30, and is disposed between the lens barrel 20 and the image sensor 51. An internal surface of the housing 30 includes a protrusion portion 31 protruding toward the optical axis X, and an edge of the infrared filter 40 is attached to the protrusion portion 31.

The infrared filter 40 removes infrared rays from the light incident through the lens within the lens barrel 20. Accordingly, when the light passing through the lens passes through the infrared filter 40, the infrared rays in the light are cut off. Therefore, the introduction of infrared rays into the image sensor 51 is prevented.

The blocking layer 60 is disposed on the infrared filter 40, and the incident external light may only be incident on the light receiving surface of the image sensor 51 due to the blocking layer 60. For example, light in the incident external light that is incident on a region other than the light receiving surface of the image sensor 51 may be blocked by the blocking layer 60. This aspect will be described in detail with reference to FIGS. 2 through 4.

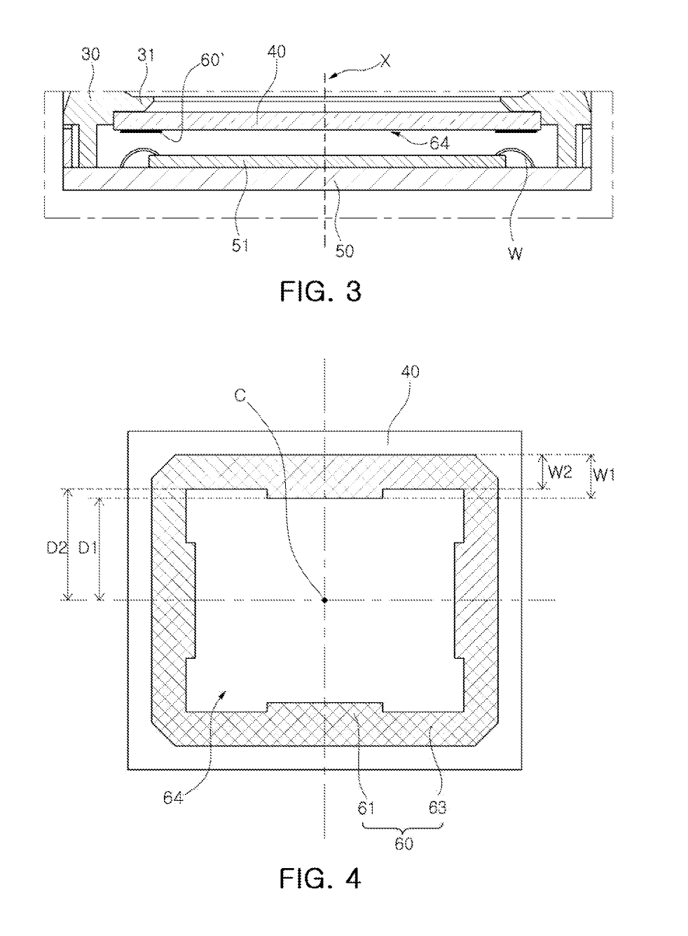

FIG. 2 is an enlarged view of part A of FIG. 1, and FIG. 3 is an enlarged view of another example of part A of FIG. 1. In addition, FIG. 4 is a plan view of the infrared filter 40 and the blocking layer 60 included in the camera module 1, according to an example.

Referring to FIG. 2, light incident on the camera module 1 passes through the lens provided in the lens barrel 20, passes through the infrared filter 40, and is collected on the light receiving surface of the image sensor 51. The light collected on the image sensor 51 is converted into an electrical signal to configure an image.

However, the light passing through the lens may be reflected from the internal surface of the housing 30, or the like, and the reflected light may arrive at the light receiving surface of the image sensor 51. In addition, even though the light passing through the lens is reflected from the internal surface of the housing 30, it may be reflected from an electronic component in the vicinity of the image sensor 51 or reflected from a bonding wire W soldered to an outer portion of the light receiving surface of the image sensor 51.

In a case in which light is reflected or scattered in an optical apparatus, the light that is reflected or scattered may be overlapped with an originally observed image of a subject, thereby reducing image quality. For instance, a flare phenomenon such as light spreading, or the like, may be generated due to the light reflected or scattered in the optical apparatus, which may have a negative influence on image quality.

Therefore, the camera module 1 includes the blocking layer 60 in order to prevent the incident external light from being reflected from an internal component, or the like, of the camera module 1.

The blocking layer 60 may be configured to allow the incident external light to only be incident on the light receiving surface of the image sensor 51, and may be configured to prevent the incident external light from being incident on the region other than the light receiving surface of the image sensor 51. Since the blocking layer 60 should not hinder the incident external light from being incident on the light receiving surface of the image sensor 51, an opening or window 64 through which the light may pass may be formed in the blocking layer 60 in alignment with the light receiving surface of the image sensor 51.

The blocking layer 60 is formed of a material that blocks light. For example, the blocking layer 60 may be a black light absorbing layer. Therefore, light other than the light incident on the light receiving surface of the image sensor 51 may be blocked based on the configuration of the blocking layer 60. More specifically, the window 64 may be formed at a predetermined size in the blocking layer 60 to allow the incident external light to be incident on the light receiving surface of the image sensor 51, and to block the incident external light from being incident on regions other than the light receiving surface.

As illustrated in FIG. 2, the blocking layer 60 is provided at edges of the infrared filter 40. For example, the blocking layer 60 may have a shape of a band continuously formed along the edge of the infrared filter 40. The blocking layer 60 may be provided on an upper surface of the infrared filter 40, as illustrated in FIG. 2, or on a lower surface of the infrared filter 40, as illustrated in FIG. 3. However, the blocking layer 60 is not limited to being provided on only one surface of the infrared filter 40, but may be provided on both of the upper and lower surfaces of the infrared filter 40.

The blocking layer 60 may be extended further toward the optical axis X in comparison to the protrusion portion 31 of the housing 30 in order to prevent the light from being incident on the region other than the light receiving surface of the image sensor 51. Since the blocking layer 60 should not hinder the light from being incident on the light receiving surface of the image sensor 51, the blocking layer 60 is formed in consideration of a size of the light receiving surface of the image sensor 51 and light refracted while passing through the lens.

However, even though the blocking layer 60 is formed in consideration of the size of the light receiving surface of the image sensor 51 and the light refracted while passing through the lens, there may be a risk that a portion of the light incident on the light receiving surface of the image sensor 51 will be blocked by mechanical tolerance between components of the camera module, or the like. For example, there may be a risk that light incident on an edge portion of the light receiving surface of the image sensor 51 will be blocked, and the edge portion of images captured by the sensor will therefore be displayed as being darker than other portions of the same images or will not be appropriately represented. Therefore, in a case of forming the blocking layer 60, mechanical tolerance between the components of the camera module, or the like, needs to be considered. To this end, in the camera module, the blocking layer 60 may have different widths. More specifically, the blocking layer 60 may include a central region 61 forming the center thereof and a corner region 63 extending outwardly from the central region 61.

For example, referring to FIG. 4, as viewed in the optical axis direction, the blocking layer 60 may have different widths W1 and W2, and the width W2 of the corner region 63 may be narrower than the width W1 of the central region 61. For instance, the corner region 63 of the blocking layer 60 may be formed to be narrower than the central region 61 of the blocking layer 60, thereby preventing the light incident on the corner portion of the light receiving surface of the image sensor 51 from being blocked. Here, the width W2 of the corner region 63 of the blocking layer 60 may be appropriately formed in consideration of mechanical tolerance between the components of the camera module 1 and performance of an optical system including the lens, and may be formed so that the light incident on the regions other than the light receiving surface of the image sensor 51 may be blocked and the light incident on the light receiving surface of the image sensor 51 is not hindered.

According to an example, in the plan view of the infrared filter 40 and the blocking layer 60 shown in FIG. 4, a vertical distance D1 from a virtual line passing through the center C of the infrared filter 40 to bisect the infrared filter 40 to the central region 61 of the blocking layer 60 and a vertical distance D2 from the virtual line to the corner region 63 of the blocking layer 60 are different from each other. For example, in the plan view of FIG. 4, the distance D2 from the virtual line bisecting the infrared filter 40 to the corner region 63 of the blocking layer 60 is greater than the distance D1 from the virtual line bisecting the infrared filter 40 to the central region 61 of the blocking layer 60. That is, the center of the blocking layer 60 may protrude further toward the optical axis X in comparison to other portions of the blocking layer 60.

For instance, in the example illustrated in FIG. 4, a ratio (D2/D1) of the distance D2 to the distance D1 may be greater than 1 and equal to or less than 2. For instance, the expression: 1<D2/D1≦2 may be satisfied.

With respect to FIG. 4, in a case in which the ratio (D2/D1) of the distance D2 to the distance D1 is equal to or less than 1, there may be a risk that a portion of the light incident on the light receiving surface of the image sensor 51 will be blocked due to mechanical tolerance between the components of the camera module, or the like.

In addition, in a case in which the ratio (D2/D1) of the distance D2 to the distance D1 exceeds 2, there may be a risk that the incident external light will be incident on a region other than the light receiving surface of the image sensor 51 and will reflected from an electronic component in the vicinity of the image sensor 51, the bonding wire W, or the like, thereby causing the occurrence of the flare phenomenon.

Through the configuration as described above, the blocking layer 60 may be provided on the infrared filter 40 to allow the incident external light to only be incident on the light receiving surface of the image sensor 51 and block the incident external light from being incident on the region other than the light receiving surface of the image sensor 51.

The infrared filter 40 and the housing 30 may be bonded to each other through an adhesive (not illustrated). An ultraviolet (UV) adhesive, a thermosetting adhesive, or the like, may be used as the adhesive.

In a case of using the UV adhesive, light for UV curing may also be blocked by the blocking layer 60, such that it may be difficult to cure the UV adhesive. Therefore, the blocking layer 60 may be spaced apart from an outer edge of the infrared filter 40 so that the light for UV curing may pass therebetween. Accordingly, the light for UV curing may pass between the outer edge of the infrared filter 40 and the blocking layer 60, such that the infrared filter 40 may be firmly attached to the housing 30 upon curing of the UV adhesive.

As set forth above, a camera module according to the examples disclosed herein prevents light passing through the lens from being incident on the region other than a light receiving surface of an image sensor. In addition, the camera module prevents the light passing through the lens from being reflected from internal components of the camera module to prevent the generation of the flare phenomenon. Further, the camera module prevents a portion of the light incident on the light receiving surface of the image sensor from being blocked due to mechanical tolerance between the components of the camera module.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a lens barrel coupled to or disposed in the housing;
an infrared filter fixed to the housing; and
a blocking layer disposed on the infrared filter,
wherein a width of a corner region of the blocking layer and a width of a central region of the blocking layer are different from each other.

2. The camera module of claim 1, wherein the width of the corner region of the blocking layer is narrower than a width of the central region of the blocking layer.

3. The camera module of claim 1, wherein the blocking layer is disposed at edges of the infrared filter.

4. The camera module of claim 1, wherein the blocking layer is spaced apart from an outer edge of the infrared filter.

5. The camera module of claim 1, wherein the blocking layer is disposed on at least one of an upper surface and a lower surface of the infrared filter.

6. The camera module of claim 1, comprising a protrusion portion disposed on an internal surface of the housing and protruding toward an optical axis, wherein an edge of the infrared filter is attached to the protrusion portion.

7. The camera module of claim 6, wherein the blocking layer protrudes further toward the optical axis in comparison to the protrusion portion.

8. The camera module of claim 1, wherein a vertical distance D1 from a virtual line bisecting the infrared filter to the central region of the blocking layer and a vertical distance D2 from the virtual line bisecting the infrared filter to the corner region of the blocking layer satisfy the expression: 1<D2/D1≦2.

9. The camera module of claim 1, further comprising an image sensor disposed below the infrared filter and having a light receiving surface, wherein the blocking layer is configured to block light from being incident on a region other than the light receiving surface.

10. The camera module of claim 9, wherein the blocking layer is a light absorbing layer.

11. The camera module of claim 9, wherein the blocking layer is black.

12. The camera module of claim 1, wherein the infrared filter is adhered to the housing by an adhesive.

13. The camera module of claim 1, wherein the central region of the blocking layer protrudes further toward an optical axis in comparison to other regions of the blocking layer.

14. A camera module comprising:
a housing;
a lens barrel coupled to or disposed in the housing;
an infrared filter fixed to the housing; and
a blocking layer disposed on the infrared filter,
wherein a first vertical distance from a virtual line bisecting the infrared filter to a central region of the blocking layer and a second vertical distance from the virtual line bisecting the infrared filter to a corner region of the blocking layer are different from each other.

15. The camera module of claim 14, wherein the second vertical distance is greater than the first vertical distance.

16. The camera module of claim 14, wherein when the first vertical distance and the second vertical distance satisfy the expression, 1<D2/D1≦2, wherein D1 denotes the first vertical distance and D2 denotes the second vertical distance.
